(19) United States
(12) Patent Application Publication
(10) Pub. No.: US 2009/0304085 A1
(43) Pub. Date: Dec. 10, 2009

(54) Adaptive Deblocking Complexity Control Apparatus and Method

(75) Inventors: Niranjan Avadhanam, San Jose, CA (US); Alexander Bronstein, San Jose, CA (US); Michael Bronstein, Santa Clara, CA (US)

Correspondence Address: Stevens Law Group, 1754 Technology Drive, Suite #226, San Jose, CA, 95110, US

(73) Assignee: Novafora, Inc., San Jose, CA (US)

(21) Appl. No.: 12/133,183

(22) Filed: Jun. 4, 2008

(51) Int. Cl. H04N 7/26; H04B 1/66

(52) U.S. Cl. 375/240.24; 375/240.29; 375/E07.075

(57) ABSTRACT

An encoder to adaptively alter video deblocking complexity is disclosed in one embodiment of the invention as including a video encoding engine to generate a stream of encoded video data. The encoded video data is characterized by a level of blocking distortion generated during the encoding process. A deblocking filter is coupled to the video encoding engine and reduces the effects of blocking distortion on the encoded video data. The deblocking filter is characterized by a level of deblocking complexity which may depend on the strength and granularity of the deblocking filter applied to the encoded video data. A resource manager is coupled to the deblocking filter and is configured to adaptively alter the deblocking complexity in order to alter the overall computational complexity of the encoder.

### BACKGROUND

This invention relates to video encoding/decoding, and more particularly to apparatus and methods for adaptively adjusting deblocking complexity to improve video coding performance.

Over the last decade, the demand for digital video products and applications has increased dramatically. Popular digital video applications include applications such as video communication and, perhaps the largest application, entertainment. Entertainment includes applications such as DVD, HDTV, satellite TV, Internet video streaming, digital camcorders, and high end video displays. A variety of newer technologies, such as HD-DVD, Blu-ray, digital video broadcasts, videophones, and digital cinema and IP set-top boxes are currently under development or have been recently deployed. Many of these video applications are now capable of being implemented in mobile devices due to increases in computational power, improvements in battery technology, and improvements in high-speed wireless connectivity.

Video compression/decompression (codec) technology is an essential enabler for all of the above-mentioned applications because it enables storage and transmission of digital video. Typical codecs may include those that comply with industry standards such as MPEG-2, MPEG-4, H.264-AVC, or those that are based on proprietary algorithms such as On2, Real Video, Nancy and Windows Media Video (now standardized as VC-1). A number of recent standards, such as H.264/AVC and VC-1, represent the latest generation of video codecs. These codecs achieve high compression ratios while maintaining exceptional video quality.

Selecting the correct codec and optimizing the codec for real-time implementation in a specific application is a formidable challenge. The optimal design typically reflects tradeoffs between compression ratios, video quality, and computational complexity. Accordingly, obtaining optimal compression efficiency with limited computational resources in both the encoder and the decoder is a difficult challenge.

In-loop filtering, also termed “deblocking,” is a process that is used in many of the video standards discussed above. For example, deblocking is used in standard video codecs such as H.263, H.264-AVC, and VC-1. In this process, a deblocking filter is applied to pixel blocks to improve visual quality by smoothing sharp edges which can form between blocks as a result of block coding techniques. The deblocking filter also facilitates motion prediction, since the deblocked frame is used as the reference frame. Consequently, in-loop deblocking filters significantly improve coding performance.

However, one significant drawback of the deblocking operation is its high computational complexity. Also, this complexity is difficult to control or scale based on computational resource availability. One alternative which has been used widely in the industry is to turn the deblocking feature off. However, this results in degraded coding performance and notable visual artifacts.

In view of the foregoing, what are needed are apparatus and methods for managing the computational complexity of the deblocking operation while retaining its visual benefits. Further needed are apparatus and methods to adaptively adjust deblocking complexity to compensate for changes in resource availability, transmission rates, and desired video quality. Further needed are apparatus and methods to adjust the granularity of the deblocking filter applied to video data. Yet further needed are apparatus and methods to manage and control the deblocking complexity based on resource availability not only in an encoder, but also in a decoder.

### BRIEF DESCRIPTION OF THE DRAWINGS

In order that the advantages of the invention will be readily understood, a more particular description of the invention briefly described above will be rendered by reference to specific examples illustrated in the appended drawings. Understanding that these drawings depict only typical examples of the invention and are not therefore to be considered limiting of its scope, the invention will be described and explained with additional specificity and detail through use of the accompanying drawings, in which:

FIG. 1 is a high-level block diagram of one embodiment of an encoder architecture in accordance with the invention;

FIG. 2 is a high-level block diagram of another embodiment of an encoder architecture in accordance with the invention;

FIG. 3 is a high-level block diagram of one embodiment of an encoding process showing frame-level control of the deblocking complexity;

FIG. 4 is a high-level block diagram of one embodiment of an encoding process showing slice-level control of the deblocking complexity;

FIG. 5 is a high-level block diagram of one embodiment of an encoding process showing macroblock-level control of the deblocking complexity;

FIG. 6 is a high-level block diagram of one embodiment of an encoding process wherein the deblocking complexity of an encoder is adjusted based on resource availability in a decoder;

FIG. 7 is a high-level block diagram of one embodiment of a deblocking complexity control module incorporated into a Rate Distortion Complexity (RDC) control module of an encoder; and

FIG. 8 is a diagram of example values for a line of four pixels in the interior of two 4×4 blocks with a block edge between P0 and Q0. This uses the same terminology as described in: Overview of the H.264/AVC Video Coding Standard, Wiegand, T.; Sullivan, G. J.; Bjntegaard, G.; Luthra, A., IEEE Transactions on Circuits and Systems for Video Technology, Volume 13, Issue 7, July 2003, Pages 560-576, and illustrates the deblock filtering process described later.

### DETAILED DESCRIPTION

The invention has been developed in response to the present state of the art, and in particular, in response to the problems and needs in the art that have not yet been fully solved by currently available encoding/decoding architectures. Accordingly, the invention has been developed to provide novel apparatus and methods for adaptively controlling deblocking complexity in encoding/decoding architectures. The features and advantages of the invention will become more fully apparent from the following description and appended claims and their equivalents, and also any subsequent claims or amendments presented, or may be learned by practice of the invention as set forth hereinafter.

Consistent with the foregoing, an encoder to adaptively alter video deblocking complexity is disclosed in one embodiment of the invention as including a video encoding engine to generate a stream of encoded video data. The encoded video data is characterized by a level of blocking distortion generated during the encoding process. A deblocking filter is coupled to the video encoding engine and reduces the effects of blocking distortion on the encoded video data. The deblocking filter is characterized by a level of deblocking complexity which may depend on the strength and granularity of the deblocking filter applied to the encoded video data. A resource manager is coupled to the deblocking filter and is configured to adaptively alter the deblocking complexity in order to alter the overall computational complexity of the encoder.

In selected embodiments, the resource manager is further configured to adaptively alter the encoding complexity in conjunction with the deblocking complexity in order to alter the overall computational complexity of the encoder. In certain embodiments, the video encoding engine and the deblocking filter are implemented using different processor cores. In other embodiments, the video encoding engine and the deblocking filter are implemented using a common processor core.

In certain embodiments, the resource manager is configured to adaptively alter the deblocking complexity based on resource availability at the encoder. In other embodiments, the resource manager is configured to adaptively alter the deblocking complexity based on resource availability of a decoder in communication with the encoder. To achieve this, the resource manager may receive feedback from the decoder with respect to the resource availability of the decoder. In certain embodiments, this feedback may be periodic.

In order to adjust and fine-tune the deblocking complexity to conform to the available resources, the resource manager may be configured to adjust the deblocking complexity with different levels of granularity. For example, the resource manager may be configured to adaptively alter the deblocking complexity on one or more of a frame level, slice level, macroblock level, and block level.

In another embodiment of the invention, a method for adaptively altering video deblocking complexity may include encoding a stream of video data to generate a stream of encoded video data. The encoded video data may be characterized by a level of blocking distortion generated during the encoding process. The method may further include filtering the encoded video data to reduce the effects of blocking distortion on the encoded video data. The filtering process may be characterized by a level of deblocking complexity depending on the strength and granularity of the deblocking filter applied to the encoded video data. The method further includes adaptively altering the deblocking complexity of the deblock filtering in order to alter the overall computational complexity of the encoding and filtering processes.

In another embodiment, an apparatus in accordance with the invention may include a decoder configured to decode a stream of encoded video data to generate a stream of decoded video data. The encoded video data may be characterized by a level of blocking complexity. A deblocking filter, associated with the decoder, may reduce the effects of blocking distortion in the decoded video data. A resource manager, associated with the decoder, may generate feedback with respect to the availability of resources to the decoder. The resource manager may transmit the feedback to an encoder to enable the encoder to alter the deblocking complexity to conform to the availability of resources in the decoder.

In yet another embodiment in accordance with the invention, a method may include decoding a stream of encoded video data to generate a stream of decoded video data. The encoded video data may be characterized by a level of deblocking complexity. The method may include filtering the decoded video data to reduce the effects of blocking distortion in the decoded video data. The method may further include generating feedback with respect to the availability of resources to the decoding process. This feedback may be sent to an encoder to enable the encoder to alter the deblocking complexity to conform to the availability of resources to the decoding process.

It will be readily understood that the components of the present invention, as generally described and illustrated in the Figures herein, may be arranged and designed in a wide variety of different configurations. Thus, the following more detailed description of the embodiments of the apparatus and methods of the present invention, as represented in the Figures, is not intended to limit the scope of the invention, as claimed, but is merely representative of selected embodiments of the invention.

Many of the functional units described in this specification are shown as modules in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose of the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, specific details may be provided, such as examples of programming, software modules, user selections, or the like, to provide a thorough understanding of embodiments of the invention. One skilled in the relevant art will recognize, however, that the invention can be practiced without one or more of the specific details, or with other methods or components. In other instances, well-known structures, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

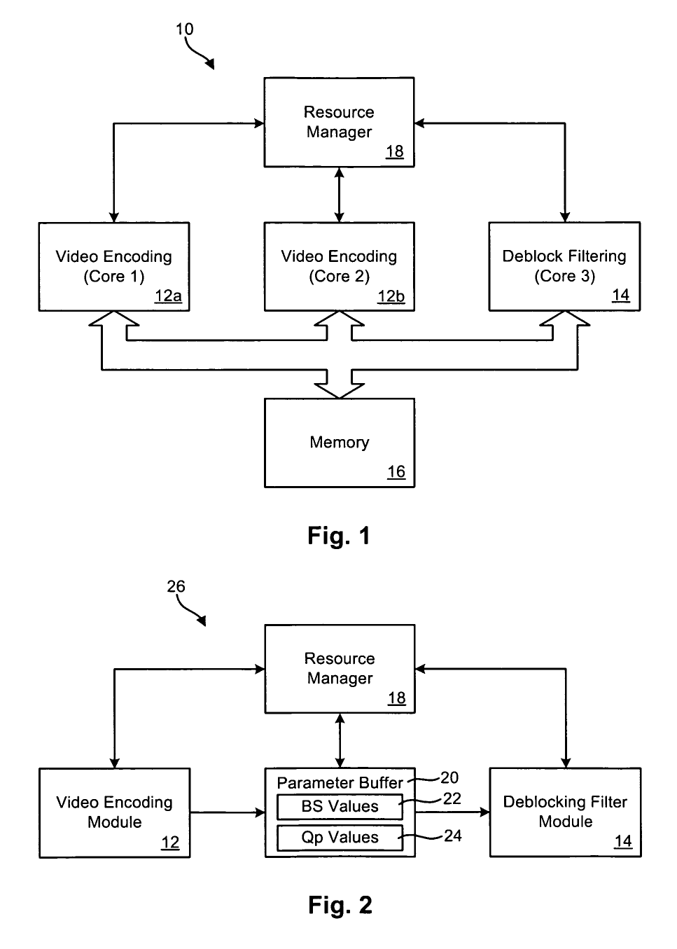

Referring to FIG. 1, in selected embodiments, a video encoder architecture 10 (e.g., an HD-AVC encoder architecture) in accordance with the invention may include a multi-core implementation where processing is distributed over several cores 12a, 12b, 14 or computational units. As illustrated, one or more cores 12a, 12b may encode the video data, and a separate core (or cores) 14 may apply a deblocking filter to the encoded video data. For the purposes of this specification, the term “encoding,” unless otherwise indicated, is used to refer to encoding operations (e.g., motion-compensated prediction, variable-length encoding, etc.) other than the deblocking process. Similarly, the phrase “overall encoding process” or language similar thereto may refer to the entire encoding process, including the deblocking process.

The illustrated embodiment 10 shows a typical solution using multiple cores 12a, 12b, 14 connected to a common memory module 16. A system resource manager 18 may manage the computational complexity of the encoding and/or deblocking processes. To accomplish this, the resource manager 18 may monitor the availability of system resources, such as processing power and memory bandwidth, to the encoder 10. The resource manager 18 may then adjust the deblocking complexity to conform to the available resources. As will be explained in more detail hereafter, by adaptively adjusting various deblocking parameters in the encoded data stream, the resource manager 18 may adaptively alter the deblocking complexity and thereby adjust the overall computational complexity of the encoding architecture 10.

Typical processors 12a, 12b, 14 used in High Definition (HD) video processing are powerful and well-suited for highly parallelized vector processing. Without the methods and techniques suggested herein, it would be difficult or impossible to control the deblocking complexity in vector architectures as the filtering is entirely input data driven. Furthermore, the in-loop deblocking operation has many instances of conditional processing even at the pixel level, making these computations quite inefficient on vector processors and the computational complexity hard to scale. In cases such as these, the methods and techniques discussed herein may be used beneficially to adjust the deblocking complexity and thereby affect the overall computational complexity of the encoding architecture 10.

In an equivalent implementation of the same encoder using scalar processors, the results of the deblocking control are more straightforward. That is, the results are more straightforward as it directly affects the overall encoder complexity, both in the sense of the overall computational complexity and memory bandwidth.

The encoding architecture 10 illustrated in FIG. 1 provides just one example of a video encoding architecture useable with an apparatus and method in accordance with the invention and is not intended to be limiting. Indeed, the apparatus and methods disclosed herein may be applicable to architectures where the encoding and deblocking are performed by the same processor core or different processor cores. Similarly, the processor cores may be either vector or scalar processors. Accordingly, the architecture 10 illustrated in FIG. 1 is presented only by way of example and is not intended to be limiting.

Furthermore, while particular reference is made herein to the H.264-AVC video compression standard, the principles discussed herein may be applicable to a wide variety of different video compression standards (e.g., H.263, VC-1, etc.), with special relevance to the emerging H.264-SVC standard. That is, intelligent modification of the deblocking parameters may be used to adaptively control the overall encoder complexity for various different video compression standards.

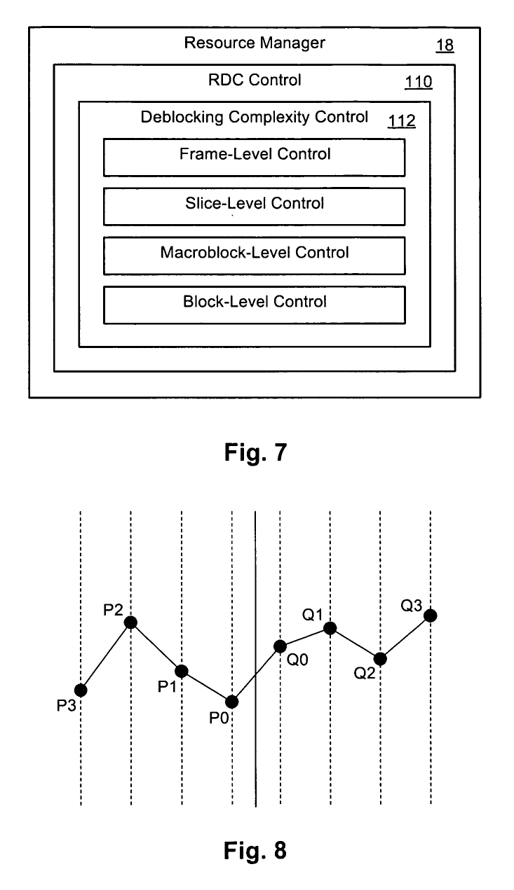

Referring to FIG. 2, in certain embodiments, a parameter buffer 20, which may contain the set of computed boundary strength (BS) values 22 and encoder-selected quantization parameter (Qp) values 24, may provide a good measure of the computational complexity of deblocking operations when encoding a video frame. Using this measure of complexity, a resource manager 18 may allocate or constrain the deblocking complexity to conform to the resources available to the encoder 26. For example, by adjusting deblocking parameters that will be discussed in association with FIG. 7, the deblocking complexity may be adjusted for each slice of a frame prior to applying the deblocking filter. FIG. 2 is a high-level block diagram showing one embodiment of an encoding architecture 26 using this procedure. This embodiment may be implemented using a single or multiple processors cores or computational units.

By adjusting the deblocking parameters, the encoder 26 may be better able to maintain real-time operation, particularly in cases where the deblocking filter 14 is the bottleneck in the processing pipeline. This mechanism may also be used to reduce the delay of the entire encoder pipeline. Furthermore, when memory bandwidth is scarce, the resource manager 18 may intelligently control the deblocking complexity to scale the memory bandwidth utilization. Using the above mechanisms, the resource manager 18 may adjust the overall computational complexity of the encoder 26 to conform to the availability of resources while still maintaining the global benefit of the deblocking operation.

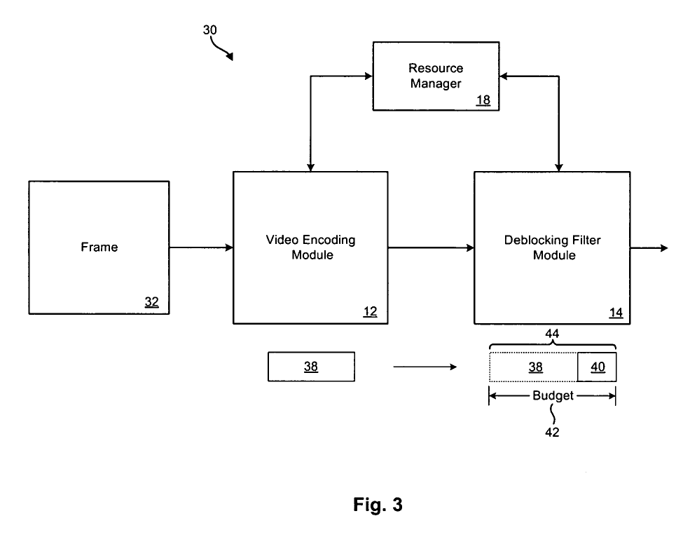

Referring generally to FIGS. 3 through 5, several examples are provided to show deblocking complexity control using different encoder architectures and different levels of granularity. That is, the deblocking complexity may be controlled on different architectures using one or more of a frame-, slice-, macroblock-, and block-level controls. The description associated with FIG. 7 will provide examples of various mechanisms for controlling the deblocking complexity using different levels of granularity. Furthermore, the examples of FIGS. 3 through 5 show that deblocking may be controlled either “explicitly,” wherein the deblocking complexity is controlled independent of the encoding process and its complexity, or “implicitly,” wherein the deblocking complexity is controlled in conjunction with the encoding process and its complexity.

Referring to FIG. 3, consider one embodiment of an encoding architecture 30 wherein deblocking is applied to an entire frame 32 using a single deblocking engine 14. In this example, the resource manager 18 may the scale the deblocking complexity to enable real-time operation when there are insufficient resources to perform both encoding and deblocking. Also, in cases where multiple slices are presented to the deblocking engine 14, assuming independence of slices for deblocking filtering purposes, the deblocking complexity for each slice may be scaled independently to achieve best possible throughput.

Furthermore, the deblocking complexity may be either scaled explicitly or implicitly. In the explicit case, the deblocking complexity may be controlled independently of the encoding complexity to conform to the available resources. That is, encoding 12 (having a corresponding encoding complexity 38) may be performed, after which the deblocking complexity 40 may be adjusted such that the overall computational complexity 44 fits within a total budget 42 constrained by the available resources. In the implicit case, the deblocking complexity may be controlled in conjunction with the encoding complexity. That is, both the encoding complexity 38 and the deblocking complexity 40 may be scaled as part of a joint complexity control operation to fit within the total budget 42 corresponding to the available resources.

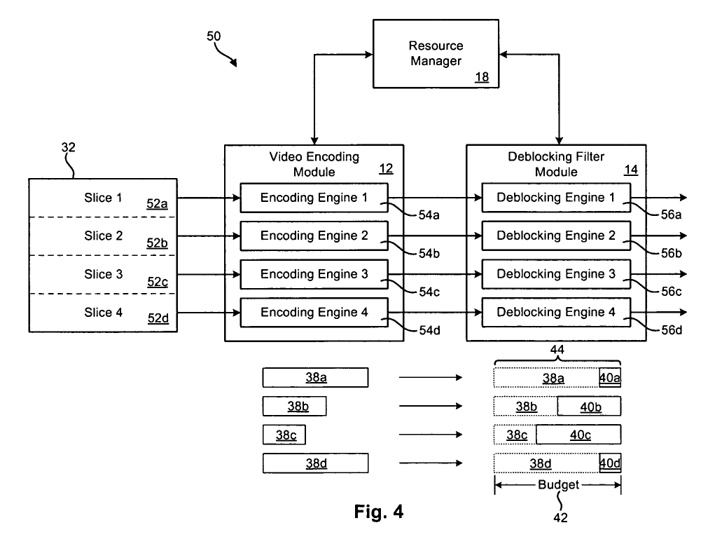

Referring to FIG. 4, consider another embodiment of an encoding architecture 50 wherein slices 52a-d are encoded by multiple encoding engines 54a-d in parallel, and deblocking is performed on each slice 52a-d by multiple deblocking engines 56a-c. Each slice 52a-d is encoded and deblocked serially by the engines 54a-d, 56a-d. Here, slice-level deblocking complexity has a direct influence on the pipeline throughput.

In selected embodiments, the deblocking complexity may be scaled either explicitly or implicitly. In the implicit case, the deblocking complexity may be controlled in conjunction with the encoding complexity. Here, the challenge is to adjust the deblocking complexity, but to do it in conjunction with the encoder complexity. The total budget for encoding and deblocking may be determined together at the same time, using joint optimization techniques which will be described later. Thus, the encoding complexity 38a-d for each slice 54a-d may be scaled, along with or after which the decoding complexity 40a-d may also be scaled such that the overall computational complexity 44 fits within a total budget 42.

In the explicit case, the deblocking complexity may be controlled independently from the encoding complexity. That is, after the encoding 12 is performed, the deblocking complexity 40a-d may be adjusted to fill in the remaining budget 42. This may optimize the utilization of available resources and may ensure that the encoding and deblocking processes for each slice 52a-d are finished at roughly the same time, improving efficiency and reducing bottlenecks. Here, the additional benefit of scaling the deblocking complexity may be to smooth out the differences in the encoding complexity.

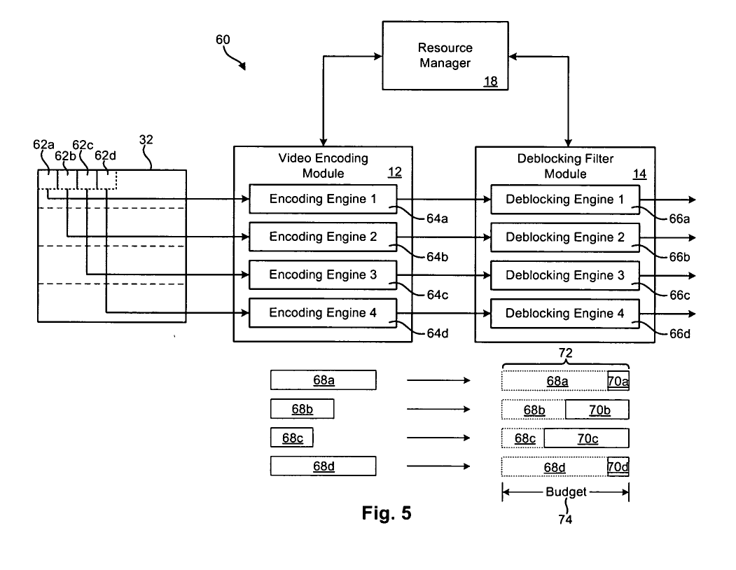

Referring to FIG. 5, consider another embodiment of an encoding architecture 60 wherein macroblocks 62a-d are encoded by multiple encoding engines 64a-d in parallel, and deblocking is performed on each macroblock 62a-d by multiple deblocking engines 66a-d. Here, the benefit of fine-grain control of the deblocking at a macroblock level is significant in balancing the overall throughput.

Like the previous examples, the deblocking complexity may be controlled either explicitly or implicitly. In the implicit case, the resource manager 18 controls the macroblock deblocking complexity in conjunction with the macroblock encoding complexity. Here, encoding decisions on a macroblock level (e.g., whether a macroblock is coded as “intra” or “inter,” etc.) may have a significant effect on the macroblock deblocking complexity. Thus, in the implicit case, encoding decisions and their effect on deblocking complexity may be taken into account and adjusted accordingly. Thus, in the implicit case, the encoding complexity 68a-d for each macroblock 62a-d may be scaled in conjunction with the deblocking complexity 70a-d such that the overall computational complexity 72 fits within a budget 74 corresponding to the available resources.

In the explicit case, the macroblock deblocking complexity is controlled independently from the macroblock encoding complexity. Here, macroblock deblocking 14 may be adjusted to fill in any remaining budget 74 after the macroblock encoding 12 is performed. Stated otherwise, the deblocking complexity may be used to smooth out differences in the encoding complexity for each macroblock. This may optimize the utilization of the available resources and may be used to ensure that the encoding and deblocking processes for each macroblock 62a-d are completed at roughly the same time.

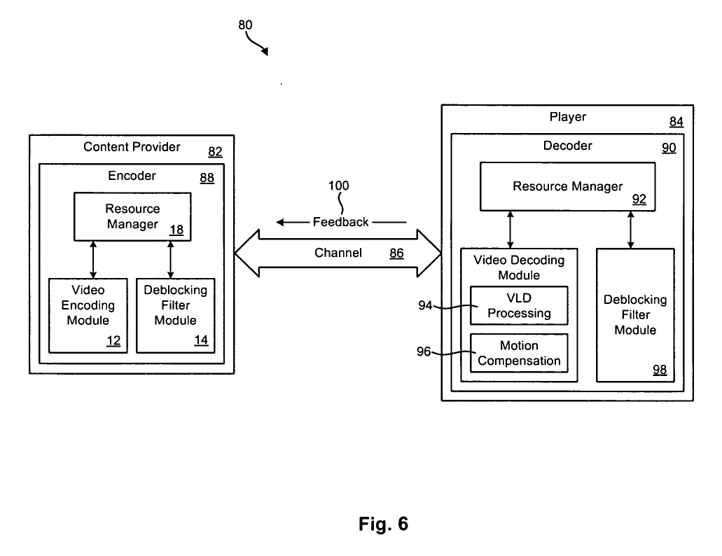

Referring to FIG. 6, in selected embodiments, the deblocking complexity at an encoder 88 may also be adjusted based on resource availability at a decoder 90. FIG. 6 shows one example of a system 80 including a content provider 82 and a player 84 communicating over a channel 86. The player 84 may be configured to play video content provided by the content provider 82. In this example, the content provider 82 includes an encoder 88 configured to generate a compressed stream of video data. The player 84 includes a decoder 90 configured to decode the compressed stream of video data for playing on the player 84.

A system 80 such as that illustrated in FIG. 6 may be found in one-way video applications such as on-demand streaming or in two-way real-time communication applications such as video conferencing or video telephony. In such applications, deblocking may be a major contributor to the overall decoding complexity (typically, close to 30 percent). Scaling of the deblocking complexity at the encoder 88 may be much better than typical solutions, which may include dropping frames at the decoder 90 when the decoding complexity exceeds the available resources or turning off the deblocking entirely.

In selected embodiments, a simple feedback mechanism may be used by the encoder 88 to track the resource availability at the decoder 90. This feedback mechanism may allow the encoder 88 to adjust the deblocking complexity such that it conforms to the available resources at the decoder 90. This may provide a significant improvement compared to dropping frames at the decoder 90 or turning off the deblocking filter altogether.

For example, consider an on-demand streaming application where a remote multi-standard decoder 90 is connected to a local encoder 88 with a feedback channel 86 as shown in FIG. 6. A resource manager 92 at the remote decoder 90 may track the resources at the decoder 90 for various computational blocks, in this example a variable-length decoding module 94, a motion compensation module 96, and a deblocking module 98. The resource manager 92 may, in certain embodiments, also track resources such as processing power and memory bandwidth that are available to the decoder 90. The local encoder 88 may receive feedback 100 with respect to the availability of resources to the decoder 90.

Using this feedback 100, the resource manager 18 of the local encoder 88 may optimize end-to-end quality by considering not only the recourse availability at the local encoder 88, but also the resource availability at the remote decoder 90, thereby yielding an optimal RDR (Rate, Distortion, Resource) solution. By jointly optimizing the rate and distortion with the encoder and decoder resources, an optimal tradeoff that maximizes utilization of all the system resources is possible.

In selected embodiments, the feedback 100 may be transmitted in a single instance, such as right before the encoder begins to encode the video data, or multiple instances, such as at various times during the encoding process. In selected embodiments, the feedback may be periodic. Periodic feedback may allow the encoder 88 to adaptively modify the deblocking complexity of the transmitted video data in response to changes in resource availability at the decoder 90. Increasing the frequency of the feedback may enable more frequent and finer-grained adjustment.

For example, if a player 84 is implemented in a remote device such as a cellular phone, media player, personal digital assistant (PDA), portable computer, or the like, resources (e.g., processing power, memory bandwidth, etc.) available to the decoder 90 may change as applications are opened or closed on the device. That is, additional applications may reduce the resources that are available to the decoder 90 and fewer applications may increase the available resources. Using feedback 100 from the decoder 90, the encoder 88 may adaptively adjust the deblocking complexity of the encoded video data to effectively utilize the resources that are available in the remote device.

Referring to FIG. 7, in selected embodiments, a resource manager 18 in accordance with the invention may include an RDC (Rate, Distortion, Complexity) control module 110 which may be responsible for making encoding tradeoffs between computational complexity, quality, and bitrate. As mentioned above in association with FIG. 6, in selected embodiments, the RDC control module 110 may be extended to an RDR (Rate, Distortion, Resource) solution wherein the RDC control module 110 considers not only the encoding complexity but also the decoding complexity. Nevertheless, in certain embodiments, the RDC control module 110 may rely primarily or exclusively on the encoder's resources when making tradeoffs.

In certain embodiments, the RDC control module 110 may include a deblocking complexity control module 112 to adjust the deblocking filter applied to the video data. In certain embodiments, the deblocking complexity control module 112 may control the deblocking filter at various levels of granularity. For example, the module 112 may control the deblocking complexity on one or more of a frame, slice, macroblock, and block level. In a more general sense, the deblocking complexity can be scaled on a global level by controlling the deblocking at various levels of granularity.

For example, the H.264-AVC standard provides various mechanisms for controlling the deblocking filter at various levels of granularity. This may accomplished using appropriate encoder coding modes and deblocking specific parameters, such as the slice-level deblock flag and the deblock offsets OffsetA and OffsetB. Using these parameters, the deblocking operation may be adaptively varied from a strong filtering operation to an extreme of virtually turning off the deblocking filtering operation altogether.

More specifically, in the H.264-AVC standard, a milder filtering operation having lower computational complexity may be performed for a slice by appropriately using the values of OffsetA and OffsetB. Furthermore, if the effective BS values can be constrained to be less than three by turning off all filtering with a BS value equal to four, all luma deblocking operations may be performed using only a short-luma filter, thereby reducing computational load and memory bandwidth. In other cases, the highest complexity mode wherein the BS is equal to four may be turned off using OffsetB. In other cases, deblocking operations may be turned off completely for a portion of a slice, tailored to the availability of resources. In yet other more extreme cases, deblocking operations may be turned off entirely for a particular slice, producing even more significant reduction of computational requirements and memory bandwidth at the expense of lower coding performance. The above examples provide a few methods and techniques that can be used to adjust the deblocking complexity using known parameters and with different levels of granularity.

The following description provides several non-limiting examples of methods and techniques for adaptively controlling the deblocking complexity for the H.264-AVC standard:

### Basic Description of the H.264-AVC Deblocking Control

The complexity of deblocking may depend on the coding mode at a macroblock level, the sample values at a pixel level, and offset parameters at a slice level. Table 1 below shows the BS values as a function of the coding mode.

TABLE 1
BS as a Function of Coding Mode

| Block modes and conditions | BS |
|---|---|
| One of the blocks is Intra AND the edge is a | 4 |
| macroblock edge | |
| One of the blocks is Intra | 3 |
| One of the blocks has coded residuals | 2 |
| Motion difference ≧ 1 pixel | 1 |
| Motion compensation from different | 1 |
| reference frames | |
| Else | 0 |

The following describes the dependence on the pixel and slice level: Consider a line of four pixels each in the interior of two 4×4 blocks where the actual block edge is between P0 and Q0. FIG. 8 is a diagram of example values for a first line of four pixels (P0, P1, P2, P3) and a second line of four pixels (Q0, Q1, Q2, Q3) with a block edge between P0 and Q0. Filtering for non-zero BS values takes place only if all three of the following conditions hold:

|P0−Q0|<α(IndexA)

|P1−P0|<β(IndexB)

|Q1−Q0|<β(IndexB)

where

IndexA=Min(Max(0, Qp+OffsetA), 51)

IndexB=Min(Max(0, Qp+OffsetB), 51)

where OffsetA and OffsetB are slice-level selectable offsets.

It should be noted that the complexity of deblocking is based on several factors. The highest complexity is for an I-slice as the BS value is set to ≧3. For P and B slices, the complexity depends on the mix of macroblock coding modes. In general, ignoring the effect of intra-macroblocks, one can expect the bi-directional motion compensation in B slices to increase the complexity. However, B slices will usually be non-reference and therefore the benefit of deblocking is only in improving visual quality (no coding gain). Incorporating the complexity model into the RD (Rate, Distortion) controller will make an intelligent tradeoff in such circumstances. In general, BS=4 allows for stronger filtering (higher complexity) and BS=1, 2, 3 allows for weaker filtering. In addition, even for BS=4, the following three conditions may determine whether a special stronger filter (highest complexity) is applied:

|P2−P0|<β(IndexB)

|Q2−Q0|<β(IndexB)

|P0−Q0|<(α>>2)+2

Hence, the available mechanisms for controlling deblocking complexity may include: (1) at a slice level, an ability to turn the deblocking on/off completely; (2) at a macroblock (MB) level, the coding modes (MB type, MV difference, Qp, reference frame selection) influence filter strength/complexity as mentioned in Table 1; (3) at a slice level, filtering can be controlled by adjusting OffsetA and OffsetB. Here, for example, these offsets may be selected to eliminate strong filtering by turning off filtering for BS=4 or by selectively turning off only the highest complexity mode for BS=4 using OffsetB. Finally, even when actions for specific BS values are not desirable, overall slice complexity (using a suitable predictor model) can be reduced by decreasing the strength of the filters using negative values for the offsets. It is important to note that all of these choices have an impact on the RD performance of the encoder.

### A Basic Deblocking Complexity Model

Presented a set of BS and Qp values for a picture frame/slice, a simple model for the complexity of luma deblocking can be expressed as (an equivalent expression can be listed for chroma filtering):

C=ΣNi×Ci

where i=1,2,3,4 and Ni is the number of edge blocks with effective BSi and Ci is the fixed cost for filtering an edge with effective BS of BSi. Here we would like to introduce the term effective BS which means that this corresponds to an active filtered edge which corresponds to a Qp value greater than 16. The choice of the Qp value may come from the consideration that the filtering is controlled by the three pixel value thresholds defined before which are controlled by:

IndexA=Min(Max(0, Qp+OffsetA), 51)

IndexB=Min(Max(0, Qp+OffsetB), 51)

where OffsetA and OffsetB are slice-level selectable offsets. For the simplified complexity model, we start with an assumption that OffsetA=OffsetB=0 and a reasonably high level of quality implying that IndexA and IndexB are equal to Qp. Further, for IndexA or IndexB below 16, the filtering is effectively turned off leading to our use of the term effective BS.

The fixed cost C(BS) varies for various processing architectures. As an example, in the article “H.264/AVC Baseline Profile Decoder Complexity Analsysis” authored by Horowitz et al. and published July 2003 in IEEE Transactions on Circuits and Systems for Video Technology, the cost quantified as operations per block edge was estimated as:

C4(BSi=4), Strong Luma filter=Cost(28×Add8+2×Mult8+12×Shift+2×Load+6×Store)

C4(BSi=4), Strong Chroma filter=Cost(20×Add8+8×Shift+2×Load+4×Store)

C1 . . . 3(BSi=1, 2, 3), Stronger Luma filter=Cost(14×Add8+6×Shift+2×Load+4×Store+6×Compare)

Given a complexity budget B for the picture frame, the deblocking complexity scale factor is hence:

S=B/C

In a situation where there is no control over coding modes, the budget B can be achieved using the following constraints:
EC(slice flag, OffsetA, OffsetB)≦B

where EC is the effective complexity and the parameters that may be controlled are the slice-level flag for deblock (on/off) and the slice-level offsets OffsetA and OffsetB.

### Mechanisms for Complexity Control

Independent (i.e.,“Explicit”) Control

In this implementation, the deblocking complexity control is independent of the encoder complexity control. This mechanism may be most suited to encoding architectures where the deblocking module is functionally separate from the encoding module. In this embodiment, the deblocking complexity control module may receive BS and Qp values for the slice/picture and estimate the complexity of the deblocking. It may then scale the complexity using two mechanisms: (1) the deblock filtering flag to turn on/off filtering at a slice level; and (2) complexity reduction by controlling the OffsetA and OffsetB parameters.

As mentioned before, the complexity budget B can be achieved using the following constraints:
EC(slice flag, OffsetA, OffsetB)≦B

where EC is the effective complexity and the controllable parameters are the slice-level flag for deblock and the slice-level offsets OffsetA and OffsetB.

The valid range for OffsetA and OffsetB includes even values between [−12, 12]. Since we consider only complexity reduction, we can restrict the range to [−12, 0] and hence there are 7×7=49 valid combinations of the [OffsetA, OffsetB] set. An optimal solution may be found by defining an appropriate complexity measure and finding a constrained optimization solution to find the best [OffsetA, OffsetB].

A simplified solution may be to calculate the complexity reduction offline for various combinations of [OffsetA, OffsetB] for a set of representative video sequences. The complexity reduction values may be computed separately for I, P, and B slices. For any new video sequence, the pre-computed values may be used to choose the value of [OffsetA, OffsetB]. If the required complexity is not met with the smallest value of [OffsetA, OffsetB], the slice_flag may be set to zero, turning off the deblocking for the whole slice. One may choose to update/adapt the pre-computed values with new values obtained after the complexity reduction is done and the filtering operation is performed. Although this is a very simple solution, it doesn't take into consideration the slice content and hence may be less than optimal.

Integrated (“Implicit”) Control

In this implementation, the deblocking control may be integrated with the encoder control. The deblocking control module may essentially add complexity-based constraints to the RD optimization solution of the encoder. These constraints may be in the form of cost functions which may couple the complexity of the deblocking with the choice of coding modes. A generalized solution for the RDC (Rate, Distortion, Complexity) optimization problem of the encoder (presented in the appended section labelled Resource Allocation Problem) may also consider encoding complexity, among other parameters. The deblocking complexity control may add the following cost function to the formula for the encoding complexity of a macroblock:

C_{db}=f(skip_{cost}, mode_{cost}, Qp_{cost}, Offset_{cost}, ref_frame_{cost}, mvdiff_{cost}, slice_flag_{cost})

where skip_{cost} quantifies the effect of a skip block on deblock complexity, mode_{cost} quantifies the effect of mode choice; and Qp_{cost}, Offset_{cost}, ref_frame_{cost}, mvdiff_{cost}, and slice_flag_{cost} are defined similarly. Note that each of these values has a specific trade-off between complexity and RD costs. For example, Offset_{cost} quantifies the complexity scaling obtained by a certain choice of [OffsetA, OffsetB]. However, as mentioned before, these values have implications on the coding performance because the extent of filtering reduces potential blocking artifacts and improves motion compensation performance as well. The cost functions would vary based on the type of slice as well as whether a macroblock is I, P, or B.

In effect, the RDC optimization may scale the complexity using these mechanisms: (1) joint control of the encoding modes; (2) complexity reduction through control of the OffsetA and OffsetB parameters; and (3) use of the deblock filtering flag to turn on/off the filtering at a slice level.

Considering the dependencies of deblocking complexity on various factors, an example of integrated mechanism for complexity control may include (1) eliminating or reducing BS=4 filtering and constraining the range to be 1 to 3. To accomplish (1), the following choices may be made during the mode selection process: (a) find the largest possible value of OffsetA/OffsetB to turn off all strong filtering, making the effectual BS less than 3; (b) selectively turn off only the highest complexity mode of BS=4 using OffsetA/OffsetB; (c) if the above is not possible, eliminate or reduce intra coding modes for the slice; (d) if the above is not possible, and if current macroblock is Intra, bias the Qp value to be as small as possible; and (e) use skip modes judiciously. In addition to (1), the complexity control may also (2) constrain the effective BS to be less than 2. This may be accomplished by increasing the Qp so that coded residuals are not present.

All of the choices presented above need to be considered within the RDC framework. For example, the optimization problem can be formulated such that the RD constraints are strictly satisfied while the complexity constraints are loosely satisfied.

Resource Allocation Problem

One of the major problems in video encoding is how to achieve best video quality (or equivalently, minimum distortion) while using a fixed amount of resources. Here, the term resources is generic and can refer to number of bits produced by the encoder, encoding time, amount of computational resources used, etc. Quality or distortion is some distance between the original video and the resulting video. This problem is referred to as optimal resource allocation.

In the most generic setting, the resource allocation problem can be stated as follows. Given the input data Y, an encoder with controllable parameters Θ, the budget of available resources represented by the K-dimensional vector R̅⁰, and a picture quality criterion Q(Θ;Y), the goal of the resource allocation algorithm is to maximize the picture quality while maintaining the utilized resources within the budget. The set of the optimal encoder parameters is therefore given as the solution to the following constrained minimization problem:

$${Θ}^{*} = {arg max}_{Θ} Q ( Θ ; Y ; V ) s . t \overline{R} ( Θ ; Y ; V ) \leq {\overline{R}}^{0} \qquad ( 1 )$$

where Θ is the set of encoder parameters for the current frame; V is some optional additional side information (for example, some uncontrollable encoder parameters); R̅(Θ;Y;V)=(R₁(Θ;Y;V), . . . ,R_{K}(Θ;Y;V)) is the vector of resources used by the encoder for frame data Y with the set of encoder parameters Θ; and Q(Θ;Y;V) is the picture quality as the result of encoding of frame data Y with the set of encoder parameters Θ.

Particular settings of the resource allocation problem are used in the majority of modern video codec algorithms. Typically, the tradeoff is performed between the distortion measured, e.g. as peak signal to noise ratio (PSNR) and the output bitrate of the encoder. The tradeoff between the two criteria is referred to as the Rate-Distortion (RD) characteristic of the codec and its optimization as the Rate-Distortion optimization (RDO) problem.

A broader setting of the problem is the Rate-Distortion-Complexity (RDC) optimization, in which in addition to rate and distortion, the optimal tradeoff also includes a computational complexity, quantifying the effort spent by the codec for encoding the input data.

The present invention addresses the problem of optimal resource allocation in video coding systems using a deblocking filter. The deblocking filter is part of the encoder and its operation is aimed at reducing the rate of the produced encoded stream and improving the picture quality. At the same time, the deblocking filter consumes significant computational complexity. We indicate the deblocking complexity by C_{d}(Θ_{d};Y) and the encoder pipeline complexity as Cₑ(Θₑ;Y). By controlling the parameters of the deblocking filter, and by choosing the encoding modes during the encoding process, it is possible to attempt to achieve an optimal tradeoff between these criteria.

For the purpose of the following discussion, we assume that the encoder consists of the encoding engine (performing operations such as motion estimation, best encoding mode selection, etc., depending on which encoding algorithm and configuration is used), controllable by the set of parameters Θₑ, and deblocking filter, controllable by the set of parameters Θ_{d}. The choice of parameters influences the quality of the encoded picture as well as the resources used by the encoder (here, assumed to be the number of bits and the computational complexity of the encoder and the deblocking filter).

The goal of optimal resource allocation is to find a set of parameters such that the quality is maximized while the utilized resources are within some given budget.

In the specific problem of RDC optimization, we distinguish between two cases. In the first case, the complexity budget of the encoding engine Cₑ(Θₑ;Y) and the deblocking filter C_{d}(Θ_{d};Y) is common (this is the case, for example, when the codec is implemented on a general purpose architecture); in the second case, the complexity budget of the encoding engine and the deblocking filter is separate (this is the case when the encoding engine and the deblocking filter are executed on different processing units).

In the first case, given the input picture data Y, the resources budget B⁰, C⁰, the RDC control problem is finding the optimal set of parameters Θ*ₑ,Θ*_{d} by solving the constrained optimization problem:

$$( {Θ}_{e}^{*} , {Θ}_{d}^{*} ) = {arg max}_{( {Θ}_{e} , {Θ}_{d} )} Q ( {Θ}_{e} , {Θ}_{d} ; Y ) s . t . \begin{matrix}B ( {Θ}_{e} , {Θ}_{d} ; Y ) \leq {B}^{0} \\ {C}_{e} ( {Θ}_{e} ; Y ) + {C}_{d} ( {Θ}_{d} ; Y ) \leq {C}^{0}\end{matrix} . \qquad ( 1 )$$

where:
Y is the input data;
C_{d}(Θ_{d};Y) is the deblocking complexity;
Cₑ(Θₑ;Y) is the encoding engine complexity;
B(Θ_{d},Θₑ;Y) is the number of bits (rate); and
Q(Θ_{d},Θₑ;Y) is the quality.

In the second case, given the input picture data Y, the resources budget B⁰, C_{d}⁰,Cₑ⁰, the RDC control problem is finding the optimal set of parameters Θ*ₑ,Θ*_{d} by solving the constrained optimization problem:

$$( {Θ}_{e}^{*} , {Θ}_{d}^{*} ) = {arg max}_{( {Θ}_{e} , {Θ}_{d} )} Q ( {Θ}_{e} , {Θ}_{d} ; Y ) s . t . \begin{matrix}B ( {Θ}_{e} , {Θ}_{d} ; Y ) \leq {B}^{0} \\ {C}_{e} ( {Θ}_{e} ; Y ) \leq {C}_{e}^{0} \\ {C}_{d} ( {Θ}_{d} ; Y ) \leq {C}_{d}^{0}\end{matrix} . \qquad ( 2 )$$

In practice, solving problems (1) and (2) would involve applying the codec to the input data for different values of the control parameters, which is computationally prohibitive. An approximate solution is possible by involving prediction—a simplified encoder model, from which its is possible to compute the approximate values of C_{d}(Θ_{d};Y), Cₑ(Θₑ;Y), B(Θ_{d},Θₑ;Y) and Q(Θ_{d},Θₑ;Y).

Problems (1) and (2) are approximated by replacing the values of C_{d}(Θ_{d};Y), Cₑ(Θₑ;Y), B(Θ_{d},Θₑ;Y) and Q(Θ_{d}, Θₑ;Y) by the respective predictors Ĉ_{d}(Θ_{d};Y), Ĉₑ(Θₑ;Y), \hat{B}(Θ_{d},Θₑ;Y) and \hat{Q}(Θ_{d},Θₑ;Y).

An example of an encoding engine model and specific examples of the predictors \hat{B}(Θ_{d},Θₑ;Y), Ĉₑ(Θₑ;Y) and \hat{Q}(Θ_{d},Θₑ;Y) are disclosed in co-pending patent application Ser. No. 12/040,788 to Bronstein et al. and entitled “Resource Allocation for Frame-Based Controller” which is herein incorporated by reference.

The invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A video encoding system inputting video data and producing encoded video data, the video encoding system comprising:
a video encoding engine generating encoded video data from input video data, the video encoding engine configurable by a first set of parameters;
a deblocking filter coupled to the video encoding engine to reduce the effects of blocking distortion on the encoded video data, the deblocking filter configurable by a second set of parameters; and
a resource manager coupled to the encoding engine and the deblocking filter to adaptively alter at least one of the first and second sets of parameters in order to produce optimally encoded video data.

2. The video encoding system of claim 1, wherein each of the first and second sets of parameters have associated therewith a set of resources utilized by the video encoding system.

3. The video encoding system of claim 2, wherein the set of resources includes at least one of computational resources, bitrate, power dissipation, data memory, and memory bandwidth.

4. The video encoding system of claim 1, wherein the resource manager is configured to adaptively alter the first and second sets of parameters separately.

5. The video encoding system of claim 1, wherein the resource manager is configured to adaptively alter the first and second sets of parameters together.

6. The video encoding system of claim 1, wherein the resource manager is configured to adaptively alter the first set of parameters only.

7. The video encoding system of claim 1, wherein the resource manager is configured to adaptively alter the second set of parameters only.

8. The video encoding system of claim 1, wherein the resource manager is configured to adaptively alter the first and second sets of parameters in order to alter the overall computational complexity of the video encoding system.

9. The video encoding system of claim 1, wherein the video encoding engine and deblocking filter are implemented using different computational units.

10. The video encoding system of claim 1, wherein the video encoding engine and deblocking filter are implemented using the same computational unit.

11. The video encoding system of claim 1, wherein the resource manager is configured to adaptively alter the first and second sets of parameters based on resource availability of the video encoding system.

12. The video encoding system of claim 1, wherein the resource manager is configured to adaptively alter the first and second sets of parameters based on resource availability of a decoder.

13. The video encoding system of claim 1, wherein the resource manager is configured to adaptively alter the first and second sets of parameters to maximize encoded video quality while utilizing an available resource budget.

14. The video encoding system of claim 12, wherein the resource manager is configured to receive feedback from the decoder with respect to the resource availability of the decoder.

15. The video encoding system of claim 14, wherein the feedback is periodic.

16. The video encoding system of claim 1, wherein the resource manager is configured to adaptively alter deblocking complexity by controlling deblocking on at least one of a frame level, a slice level, a macroblock level, and a block level.

17. A method for adaptively altering video deblocking complexity, the method comprising:
encoding a stream of video data to generate a stream of encoded video data characterized by a level of blocking distortion;
filtering the encoded video data to reduce the effects of blocking distortion on the encoded video data, the filtering being characterized by a level of deblocking complexity; and
adaptively altering the deblocking complexity in order to alter the overall computational complexity of the encoding and filtering.

18. The method of claim 17, wherein the encoding is characterized by a level of encoding complexity.

19. The method of claim 18, further comprising adaptively altering the encoding complexity in order to alter the overall computational complexity of the encoding and filtering.

20. The method of claim 17, wherein encoding and filtering comprises encoding using a first processor core and filtering using a second processor core.

21. The method of claim 17, wherein encoding and filtering comprises encoding and filtering using the same processor core.

22. The method of claim 17, wherein adaptively altering the deblocking complexity comprises altering the deblocking complexity based on resource availability associated with the encoding and filtering.

23. The method of claim 17, wherein adaptively altering the deblocking complexity comprises altering the deblocking complexity based on resource availability associated with decoding the encoded video data;

24. The method of claim 23, further comprising receiving periodic feedback with respect to the resource availability associated with the decoding.

25. The method of claim 17, wherein adaptively altering the deblocking complexity comprises adaptively alter the deblocking complexity on at least one of a frame level, a slice level, a macroblock level, and a block level.

26. An apparatus comprising:
a decoder configured to decode a stream of encoded video data to generate a stream of decoded video data, the encoded video data being characterized a level of deblocking complexity.
a deblocking filter associated with the decoder to reduce the effects of blocking distortion in the decoded video data;
a resource manager associated with the decoder and generating feedback with respect to the availability of resources in the decoder; and
the resource manager configured to transmit the feedback to an encoder to enable the encoder to alter the deblocking complexity to conform to the availability of resources in the decoder.

27. The apparatus of claim 26, wherein the resources include at least one of processing resources and memory bandwidth.

28. The apparatus of claim 26, wherein the feedback is periodic feedback.

29. The apparatus of claim 26, wherein the encoder is configured to alter the deblocking complexity on at least one of a frame level, a slice level, a macroblock level, and a block level.

30. A method comprising:
decoding a stream of encoded video data to generate a stream of decoded video data, the encoded video data being characterized a level of deblocking complexity.
filtering the decoded video data to reduce the effects of blocking distortion in the decoded video data;
generating feedback with respect to the availability of resources to the decoding process; and
sending the feedback to an encoder to enable the encoder to alter the deblocking complexity to conform to the availability of resources to the decoding process.

31. The method of claim 30, wherein the resources include at least one of processing resources and memory bandwidth.

32. The method of claim 30, wherein generating feedback comprises generating periodic feedback.

33. The method of claim 30, wherein altering the deblocking complexity comprises altering the deblocking complexity on at least one of a frame level, a slice level, a macroblock level, and a block level.
